(19) United States
(12) Patent Application Publication
(10) Pub. No.: US 2018/0308034 A1
(43) Pub. Date: Oct. 25, 2018

(54) New Foamed Diverter/Sand Control Model for Fluid Diversion in Integrated Wellbore-Reservoir System

(71) Applicant: Halliburton Energy Services, Inc., Houston, TX (US)

(72) Inventors: Srinath Madasu, Houston, TX (US); Loan Vo, Houston, TX (US)

(73) Assignee: Halliburton Energy Services, Inc., Houston, TX (US)

(21) Appl. No.: 15/768,413

(22) PCT Filed: Dec. 11, 2015
(86) PCT No.: PCT/US2015/065347

§ 371 Date: Apr. 13, 2018

(51) Int. Cl. G06Q 10/06

(52) U.S. Cl. CPC G06Q 10/06395; E21B 23/002; G06Q 10/067

(57) ABSTRACT

Methods and systems are presented in this disclosure for modeling fluid diversion in an integrated wellbore-reservoir system. A mathematical model for fluid diversion in a reservoir formation of the integrated wellbore-reservoir system is generated by capturing, within the model, combined effects of formation treatments by foaming agent and by a chemical agent (such as resin) that imposes skin effect and permeability reduction to the formation. The generated model can be employed to simulate treatment of the reservoir formation by the foamed resin system. Based on results of the simulated treatment, treatment of the reservoir formation by the foamed resin system can be initiated for fluid diversion among layers of different permeabilities in the reservoir formation.

### TECHNICAL FIELD

The present disclosure generally relates to wellbore and reservoir simulations and, more particularly, to modeling fluid diversion in integrated wellbore-reservoir systems.

### BACKGROUND

Various treatment fluids may be used in a variety of subterranean treatments, including, but not limited to, stimulation treatments and sand control treatments. As used herein, the term “treatment,” or “treating,” refers to any subterranean operation that uses a fluid in conjunction with a desired function and/or for a desired purpose. The terms “treatment,” and “treating,” as used herein, do not imply any particular action by the fluid or any particular component thereof. Examples of common subterranean treatments include, but are not limited to, drilling operations, fracturing operations (including prepad, pad and flush), perforation operations, sand control treatments (e.g., gravel packing, resin consolidation including the various stages such as preflush, afterflush, etc.), acidizing treatments (e.g., matrix acidizing or fracture acidizing), “frac-pack” treatments, cementing treatments, water control treatments, wellbore clean-out treatments, paraffin/wax treatments, scale treatments and “squeeze treatments.”

In subterranean treatments, it is often desired to treat an interval of a subterranean formation having sections of varying permeability, reservoir pressures and/or varying degrees of formation damage, and thus may accept varying amounts of certain treatment fluids. For example, low reservoir pressure in certain areas of a subterranean formation or a rock matrix or a proppant pack of high permeability may permit that portion to accept larger amounts of certain treatment fluids. It may be difficult to obtain a uniform distribution of the treatment fluid throughout the entire interval. For instance, the treatment fluid may preferentially enter portions of the interval with low fluid flow resistance (e.g., high permeability portions) at the expense of portions of the interval with higher fluid flow resistance (e.g., low permeability portions).

In conventional methods of treating such subterranean formations, once the less fluid flow-resistant portions of a subterranean formation have been treated, that area may be sealed off using a variety of techniques in order to divert treatment fluids into more fluid flow-resistant portions of the interval. Such techniques may involve, among other things, the injection of particulates, foams, emulsions, plugs, packers, or blocking polymers (e.g., cross-linked aqueous gels) into the interval so as to plug off high-permeability portions of the subterranean formation once they are treated, thereby diverting subsequently injected fluids to more fluid flow-resistant portions of the subterranean formation.

Modeling and simulation of fluid diversions among portions of a subterranean formation having different levels of fluid resistivity (or, equivalently, permeability) based on application of a specific diverter in the subterranean formation around a wellbore is essential for accurate prediction of diverter effects on flow distribution inside the reservoir formation. A model for fluid diversion should be able to accurately and quickly predict permeability levels of treated portions of the reservoir formation, viscosity of the diverter and skin effect due to injection of the diverter.

The conventional foam diverter model considers foaming agent to be a Newtonian fluid. Hence, if the permeability of foam is greater than a minimum permissible permeability, then the viscosity of foam can be computed as:

$$μ = {( \frac{k}{9.86 {e}^{- 16}} )}^{0.3} . \qquad ( 1 )$$

Further, if the permeability of foam is less than the minimum permissible permeability, then the viscosity of foam can be computed as:

$$μ = {( \frac{{k}_{min}}{9.86 {e}^{- 16}} )}^{0.3} . \qquad ( 2 )$$

Since only a portion of the foam contributes to fluid flow when the gas in the foam block the fluid flow, a foam viscosity value is multiplied by a factor that depends on a foam quality (e.g., the factor being equal to 1−foam quality). If the foam viscosity value is less than 0.3, then the foam viscosity in the foam diverter model is capped at 0.3. This value of the foam viscosity is then used in simulations related to some wellbore-reservoir systems.

There are several drawbacks of the conventional foam diverter model. First, there is no physical basis for this foam diverter model. Second, permeability change due to foam effect is not accounted in the conventional foam diverter model. Third, permeability change due to resin (or chemical) coating on a subterranean formation is not accounted in the conventional foam diverter model. Fourth, the viscosity of foam used in the conventional foam diverter model is not based on experimental data.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a cross-sectional view of a system configured for delivering treatment fluids comprising diversion compositions to a subterranean formation, according to certain embodiments of the present disclosure.

FIG. 2 is a cross-sectional view of a wellbore-reservoir system employing open-hole completion operation with a treatment fluid, according to certain embodiments of the present disclosure.

FIG. 3 is a block diagram illustrating combining a foam model and a skin resin model into a combined model for fluid diversion applications, according to certain embodiments of the present disclosure.

FIG. 4 is a flow chart of a method for simulating fluid diversion based on a model that combines both foam effects and resin effects, according to certain embodiments of the present disclosure.

FIG. 5 illustrates a cross-sectional view of a wellbore with a treatment fluid and formation segmented into a plurality of segments having different levels of permeability, according to certain embodiments of the present disclosure.

FIG. 6 is a cross-sectional view of a wellbore and formation after a treatment with liquid fluids, according to certain embodiments of the present disclosure.

FIG. 7 is a cross-sectional view of a wellbore and formation after a simulated treatment with foam followed by a liquid when two different simulation models are used, according to certain embodiments of the present disclosure.

FIG. 8 is a cross-sectional view of a wellbore and formation after a simulated treatment with a liquid followed by foam when two different simulation models are used, according to certain embodiments of the present disclosure.

FIG. 9 is a cross-sectional view of a wellbore and formation after a simulated two-step treatment with foam when two different simulation models are used, according to certain embodiments of the present disclosure.

FIG. 10 is a flow chart of a method for modeling fluid diversion, according to certain embodiments of the present disclosure.

FIG. 11 is a block diagram of an illustrative computer system in which embodiments of the present disclosure may be implemented.

### DETAILED DESCRIPTION

Embodiments of the present disclosure relate to modeling fluid diversion in integrated wellbore-reservoir systems. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one ordinarily skilled in the art to implement such feature, structure, or characteristic in connection with other embodiments whether or not explicitly described. It would also be apparent to one ordinarily skilled in the relevant art that the embodiments, as described herein, can be implemented in many different embodiments of software, hardware, firmware, and/or the entities illustrated in the Figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding Figure and the downward direction being toward the bottom of the corresponding Figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those ordinarily skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those ordinarily skilled in the art that the apparatus according to the present disclosure is equally well suited for use in onshore operations and vice-versa. Further, unless otherwise noted, even though a Figure may depict a cased hole, it should be understood by those ordinarily skilled in the art that the apparatus according to the present disclosure is equally well suited for use in open hole operations.

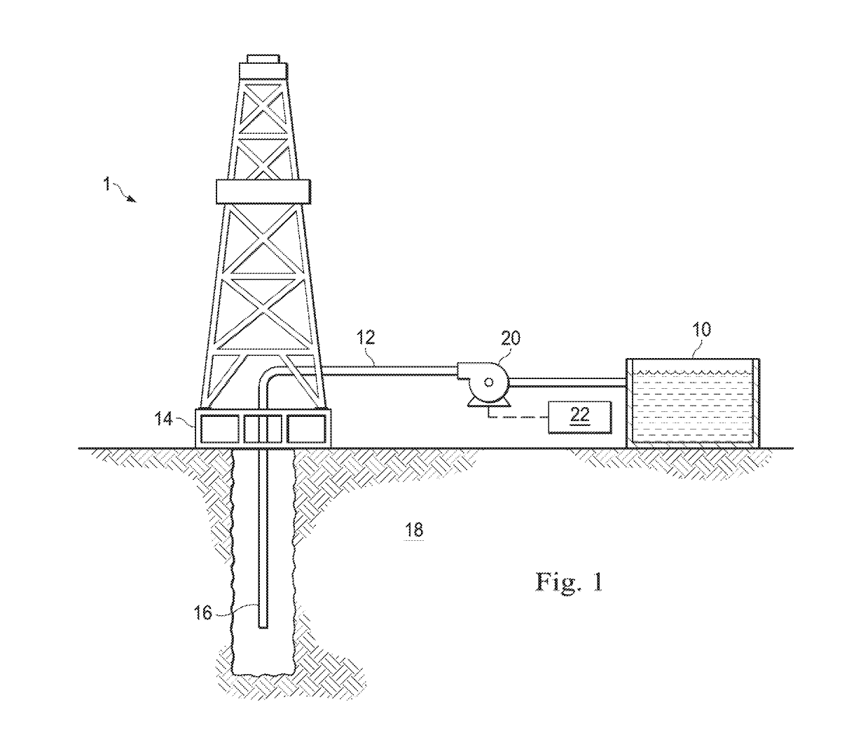

Illustrative embodiments and related methods of the present disclosure are described below in reference to FIGS. 1-11 as they might be employed for modeling fluid diversion in integrated wellbore-reservoir systems. Such embodiments and related methods may be practiced, for example, using a computer system as described herein. Other features and advantages of the disclosed embodiments will be or will become apparent to one of ordinary skill in the art upon examination of the following Figures and detailed description. It is intended that all such additional features and advantages be included within the scope of the disclosed embodiments. Further, the illustrated Figures are only exemplary and are not intended to assert or imply any limitation with regard to the environment, architecture, design, or process in which different embodiments may be implemented.

Embodiments of the present disclosure provide a new mathematical model for simulating the diverting effect of a foamed resin system when the foamed resin system is applied to a reservoir formation to facilitate preventing formation sand from being produced during well production. The foam diversion mathematical model presented herein can be also applied on any fluid diversion application when a treating chemical imposes a formation permeability reduction (i.e., formation damage) and applications such as sand control, proppant flow back control, conformance water shut-off, fracturing, and the like.

The present disclosure presents a one-dimensional diversion/sand control model for foamed resin diversion system computations inside an integrated wellbore-reservoir system. In accordance with embodiments of the present disclosure, certain features are included into the foamed resin diverter/sand control simulator presented herein, such as permeability reduction in the reservoir due to gas immobility in the foam, viscosity of foam computations, and skin effect due to resin application. The diverter/sand control simulator built in the present disclosure employs a semi-empirical model for foaming agent based on local equilibrium. The approach presented herein provides a model for the reduction in formation permeability due to the presence of foam and increase of foam viscosity, as well as for emulating the effect of skin generation due to resin polymer and foam that can be incorporated in the model simulator for flow computations.

FIG. 1 shows an illustrative schematic of a system that can deliver treatment fluids to a subterranean formation including chemical agents for fluid diversion that is modeled herein, according to certain illustrative embodiments of the present disclosure. It should be noted that while FIG. 1 generally depicts a land-based system, it is to be recognized that like systems may be operated in subsea locations as well. As depicted in FIG. 1, system 1 may include mixing tank 10, in which a treatment fluid disclosed in some embodiments herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like. System 1 may further include a computing system 22 that models one or more aspects of the fluid treatment, including modeling of fluid diversion discussed in more detail below. In one or more embodiments, pump 20 may be coupled to computing system 22 and may receive control instructions from computing system 22 in relation to controlling of the fluid treatment process, including tuning, or parameterizing based on information in real time or based on prior treatments (e.g., prior treatments in similar settings).

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

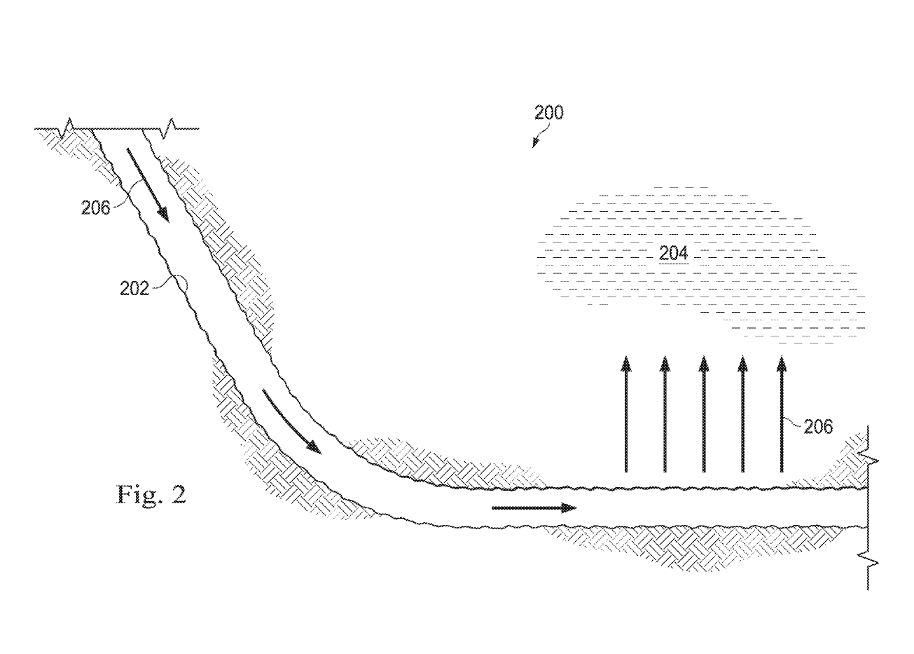

FIG. 2 is a cross-sectional view of an integrated wellbore-reservoir system 200 employing open-hole completion operation with a treatment fluid, according to certain illustrative embodiments of the present disclosure. FIG. 2 depicts a slanted wellbore 202 having a horizontal portion and a vertical portion penetrating a reservoir formation 204. However, it should be understood by those ordinarily skilled in the art that the diverter/sand control model presented in this disclosure can be applied to integrated wellbore-reservoir systems with wellbores having other orientations including horizontal wellbores, vertical wellbores, multilateral wellbores, or the like. The wellbore-reservoir system 200 illustrated in FIG. 2 may be treated by injecting a fluid 206 (e.g., foamed resin) into different layers of the reservoir formation 204.

In one or more embodiments, a skin generated due to resin cake deposition in the reservoir formation 204 may be calculated for open-hole completions (e.g., open-hole completion of the integrated wellbore-reservoir system 200 of FIG. 2) as follows:

ϕ_{Resin}=0.1ϕ_{formation}, (3)

where ϕ_{Resin} is a porosity of resin cake, and ϕ_{formation} is a porosity of formation. The mass balance may be defined as:

$$\begin{matrix}u 2 π {R}_{w} l Δ {tC}_{Resin} = ( 1 - {φ}_{Resin} ) 2 π ( {R}_{w} - d ) l Δ d , & ( 4 ) \\ Δ d = \frac{{uR}_{w} {C}_{Resin} Δ t}{( 1 - {φ}_{Resin} ) ( {R}_{w} - d )} , & \\ d = {d}_{o} + Δ d , & \\ {d}_{o} = d , & \end{matrix}$$

where u is a velocity of resin, R_{w} is a wellbore radius, l is a length of a formation layer where resin is injected, Δt is a time interval for resin injection, C_{Resin} is a volume concentration of resin, d is an updated resin cake thickness, dₒ is an initial cake thickness, and Δd is a difference between the updated cake thickness and the initial cake thickness.

In one or more embodiments, updating the resin cake thickness from dₒ to d gives a new effective skin S due to resin cake deposition as follows:

$$S = ( \frac{K}{{K}_{Resin}} - 1 ) log ( \frac{d + {R}_{w}}{{R}_{w}} ) , \qquad ( 5 )$$

where K is an initial permeability of a formation layer, and K_{Resin} is a permeability of the formation layer after resin injection. A fluid flow rate in the formation layer after resin injection and generation of skin due to resin cake deposition may be given as:

$$q = \frac{2 π K Δ Pl}{μ ( log \frac{{R}_{1}}{{R}_{w}} + S )} , \qquad ( 6 )$$

where ΔP is a pressure drop through the resin cake, and R₁ is a radius of the first element nodal location.

In one or more embodiments, reduction of permeability of a formation layer due to the presence of foam may occur. The viscosity of foam may be computed as:

$${μ}_{f} = {μ}_{g} + \frac{α {n}_{f}}{{v}_{g}^{1 / 3}} , \qquad ( 7 )$$

where μ_{g} is a viscosity of flowing gas, n_{f} is a number of foam bubbles, α is a constant of proportionality that varies with surfactant and permeability, and v_{g} is a velocity of flowing gas.

Assuming local equilibrium between foam generation and coalescence rates, the following model may be used to determine the number of foam bubbles:

$${( \frac{{n}_{f}}{{n}^{*}} )}^{w} + \frac{{k}_{- 1} {\vert {v}_{f} \vert}^{2 / 3}}{{k}_{1}^{o} {v}_{w}} {n}_{f} - 1 = 0 , \qquad ( 8 )$$

where n* is a number of bubbles at the limiting capillary pressure, v_{w} is a velocity of water, v_{f} is a velocity of foam, k₋₁ is a foam generation constant, k₁^{o} is a coalescence rate constant and w is a constant (e.g., having the value of 3). In one or more embodiments, the equation (8) represents a cubic equation in terms of

$$( \frac{{n}_{f}}{{n}^{*}} ) ,$$

and the positive root of the solution of equation (8) is given as:

$$( \frac{{n}_{f}}{{n}^{*}} ) = {\{ \frac{1}{2} + \sqrt{( \frac{1}{4} + {( \frac{{k}_{- 1} {\vert {v}_{f} \vert}^{2 / 3}}{{k}_{1}^{o} {v}_{w}} )}^{3} )} \}}^{1 / 3} - {\{ \vert \frac{1}{2} - \sqrt{( \frac{1}{4} + {( \frac{{k}_{- 1} {\vert {v}_{f} \vert}^{2 / 3}}{{k}_{1}^{o} {v}_{w}} )}^{3} )} \vert \}}^{1 / 3} . \qquad ( 9 )$$

In one or more embodiments, equation (9) can be applied to compute the number of foam bubbles n_{f}. Subsequently, the computed number of foam bubbles can be used to determine viscosity and permeability of a formation layer after foam injection. For example, permeability of the formation layer after foam injection K_{f} may be obtained in accordance with:

$$\frac{{K}_{f}}{K} = {( 1 - {X}_{tmax} ( \frac{β {n}_{f}}{1 + β {n}_{f}} ) )}^{2.2868} , \qquad ( 10 )$$

where Xₜₘₐₓ is a maximum fraction of the trapped gas saturation (e.g., Xₜₘₐₓ=0.8) and β is a gas trapping parameter.

In one or more embodiments, the permeability of formation layer may decrease in the presence of the foam due to gas immobility. In addition, viscosity of foam is higher than that of the pure gas. Hence, the fluid flow rate given by equation (6) decreases. Furthermore, the effective skin factor increases in the presence of resin as given by equation (5), which further decreases the fluid flow rate given by equation (6), and hence the fluid diversion occurs.

In accordance with certain embodiments of the present disclosure, the mathematical model for foam diversion presented herein can also be applied to any diversion application when a treating chemical imposes a permeability reduction to the reservoir formation (i.e., formation damage), such as, but not limited to, sand control, proppant flow back control, conformance water shut-off, fracturing, and the like.

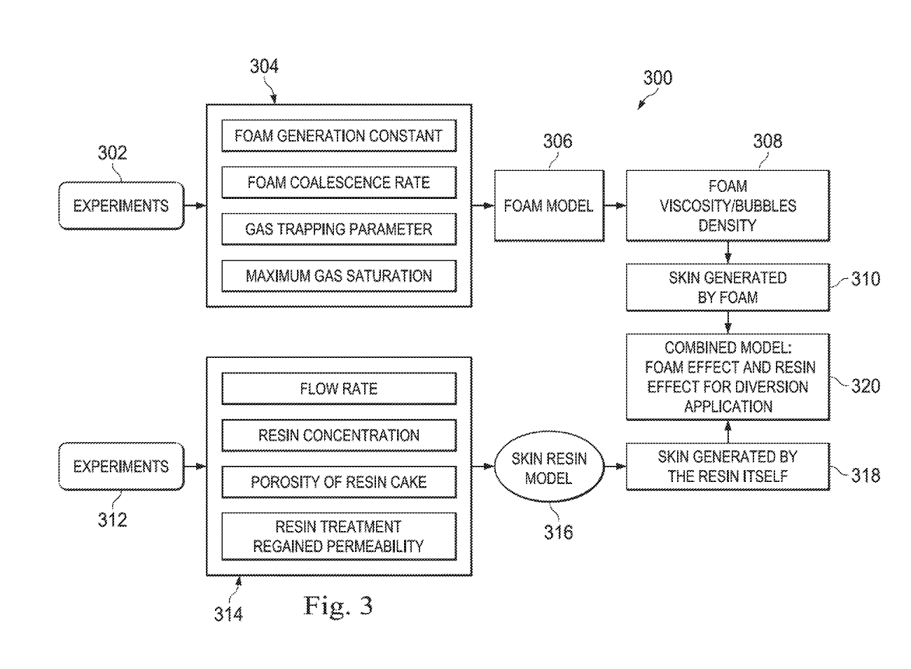

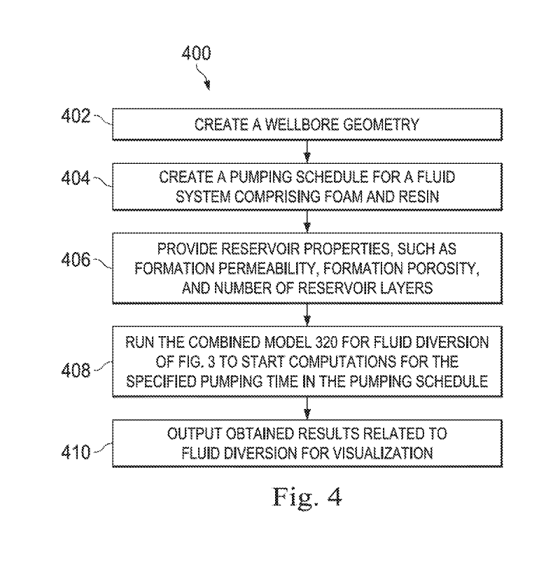

FIG. 3 illustrates a block diagram 300 of a method for combining a foam model and a skin resin model into a combined model for fluid diversion applications, according to certain illustrative embodiments of the present disclosure. In one or more embodiments, based on experiments 302, several foam related parameters 304 may be obtained, such as the foam generation constant k₋₁, the foam coalescence rate k₁^{o}, the gas trapping parameter β, and the maximum gas saturation Xₜₘₐₓ. For certain embodiments, based on the foam related parameters 304, foam model 306 may be built. The foam model 306 may provide information 308 about foam viscosity and bubbles density, which may be used to obtain information 310 about skin generated by injecting foam into formation.

As further illustrated in FIG. 3, based on experiments 312, several resin related parameters 314 may be obtained, such as the flow rate q, the resin concentration C_{Resin}, the porosity of resin cake ϕ_{Resin} and the permeability regained based upon the resin treatment K_{Resin}. In one or more embodiments, skin resin model 316 may be built based on the resin related parameters 314, and may provide information 318 related to skin generated by the resin itself. In accordance with certain embodiments of the present disclosure, information 310 about skin generated by foam and information 318 about skin generated by resin may be utilized to generate a combined model 320 for fluid diversion in a reservoir formation by capturing, within the model 320, combined effect of skin generated by foam injection and skin generated by resin injection. In one or more embodiments, model 316 may provide modeling of formation treatment by a chemical agent other than the resin that provides skin effect and an increase in viscosity due to the foam injection to impose small pressure gradient effect to the formation causing fluid diversion.

FIG. 4 illustrates a flow chart 400 of a method for simulating fluid diversion based on the fluid diversion model 320 of FIG. 3 that combines both foam skin effect and resin skin effect (or skin effect of some other chemical agent), according to certain illustrative embodiments of the present disclosure. At 402, a wellbore geometry may be created. At 404, a pumping schedule may be created for a fluid diverter system comprising foam and resin. At 406, properties of a reservoir formation may be provided, such as formation permeability, formation porosity, and number of reservoir layers. At 408, the combined model 320 for fluid diversion of FIG. 3 may be run to start computations for the specified pumping time in the pumping schedule. At 410, obtained simulation results related to fluid diversion may be output for visualization.

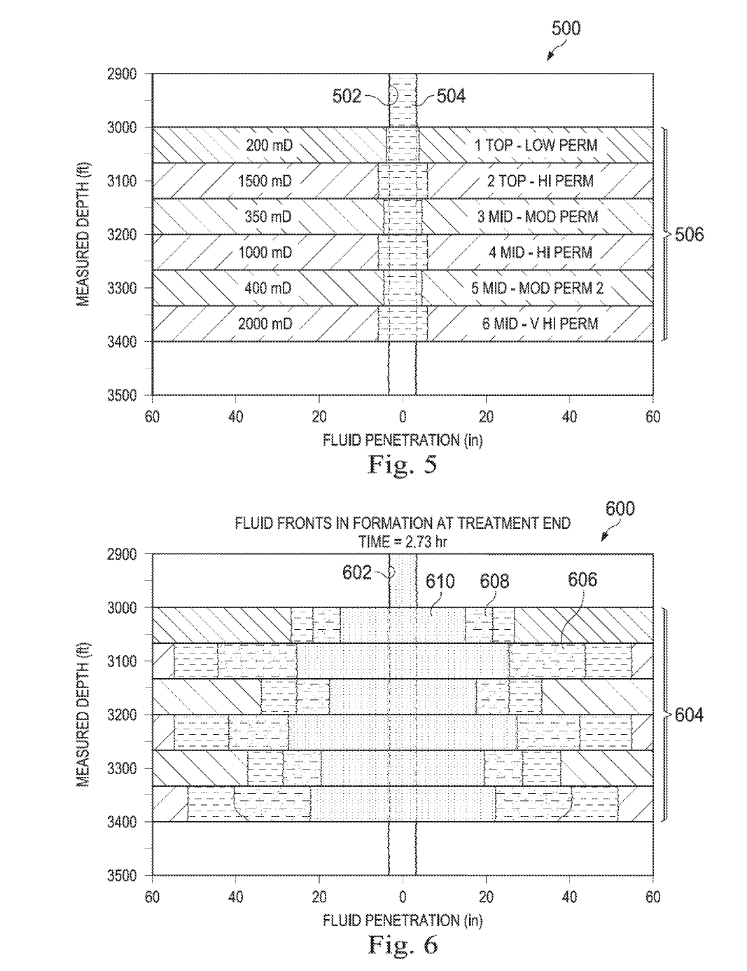

The model for fluid diversion applications presented in this disclosure that combines effects of foam and resin (or some other chemical agent with skin effect) may be tested based on experimental studies. The modeling experimental study presented herein involves the treatment of a resin consolidation into a 400-ft interval of a reservoir formation around a wellbore. For the simplified scenario of the experimental study, the 400-ft formation interval can be segmented into six equal segments (formation layers), each having a different permeability. FIG. 5 illustrates a cross-sectional view 500 of a wellbore 502 with a treatment fluid 504 and a reservoir formation 506 segmented into a plurality of segments (layers) having different permeability levels, according to certain illustrative embodiments of the present disclosure. The treatment simulated herein accounts two main operations: the first operation may comprise pre-flush treatment with potassium chloride solution (KCl) to ensure that the formation around the wellbore is water wet; the second operation may comprise treatment of the formation with the consolidation resin system. In one or more embodiments, the consolidation resin system may comprise an aqueous based curable resin system and a foaming agent.

FIG. 6 illustrates a cross-sectional view 600 of a wellbore 602 and a reservoir formation 604 after a two-phase treatment where chemical agents in both treatment operation phases are liquids, according to certain illustrative embodiments of the present disclosure. As illustrated in FIG. 6, the treatment with only a liquid fluid (e.g., KCl) provides that most fluid still preferentially enters high permeability zones (e.g., zone 606 illustrated in FIG. 6) over lower permeability zones (e.g., zone 608 illustrated in FIG. 6). After injection of another liquid fluid (e.g., consolidation resin system), equalization of permeability levels across different formation zones may be further improved, resulting into higher equilibration of fluid treatment due to fluid diversion (e.g., from higher permeability zones to lower permeability zones), as illustrated by treatment fluid 610 in FIG. 6.

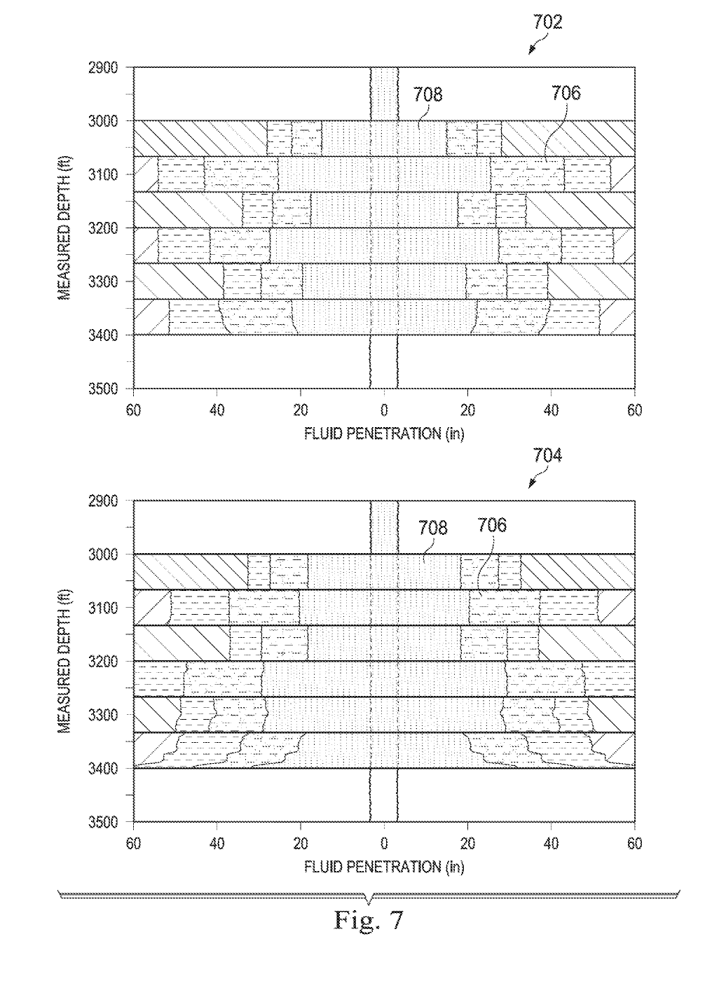

In the first illustrative simulation scenario presented herein, the treatment may comprise two operations: injection of foam into a subterranean formation followed by injection of a liquid into the subterranean formation. FIG. 7 illustrates cross-sectional views 702 and 704 of an integrated wellbore-reservoir system after a simulated treatment with foam (e.g., treatment fluid 706) followed by a liquid (e.g., treatment fluid 708) when two different simulation models are used, according to certain illustrative embodiments of the present disclosure. The simulated cross-sectional view 702 can be obtained by applying a basic foam diversion mathematical model where permeability change due to foam effect is not accounted and viscosity of foam is not based on experimental data. The simulated cross-sectional view 704 can be obtained by applying a diversion model presented in this disclosure that captures combined effect of foaming agent and resin (or some other chemical agent that provides permeability reduction and skin effect).

Simulation results illustrated at the cross-sectional view 702 indicate that the basic foam model does not demonstrate any effect of foam treatment as a diverting agent. The theory predicted that foam viscosity and its bubble sizes and density provide blockages in a porous media, which generates a mechanism for permeability ‘equilibration’ whenever formation is treated by foam. The simulation results illustrated at the cross-sectional view 702 clearly indicate that the basic foam model fails to emulate this effect, i.e., permeability equilibration among a plurality of formation layers is not sufficient.

By utilizing the combined fluid diversion model (e.g., the model 320 of FIG. 3), bubble size density of the foamed KCl and its viscosity changes are applied. The simulation results shown at the cross-sectional view 704 clearly indicate equilibration of permeability allowing the treatment fluid to enter the formation more equally. In the simulation when the combined fluid diversion model is applied, the foamed KCl provides an equilibration of permeabilities in the formation (e.g., treatment fluid 706 in FIG. 7), and treatment of the liquid resin provides an additional diverting effect from its skin model (e.g., treatment fluid 708 in FIG. 7). Thus, the treatment simulated in FIG. 7 allows for more treatment fluids being delivered to lower permeability zones. In one or more embodiments, the diversion effect can be even higher when a pump rate is tailored differently.

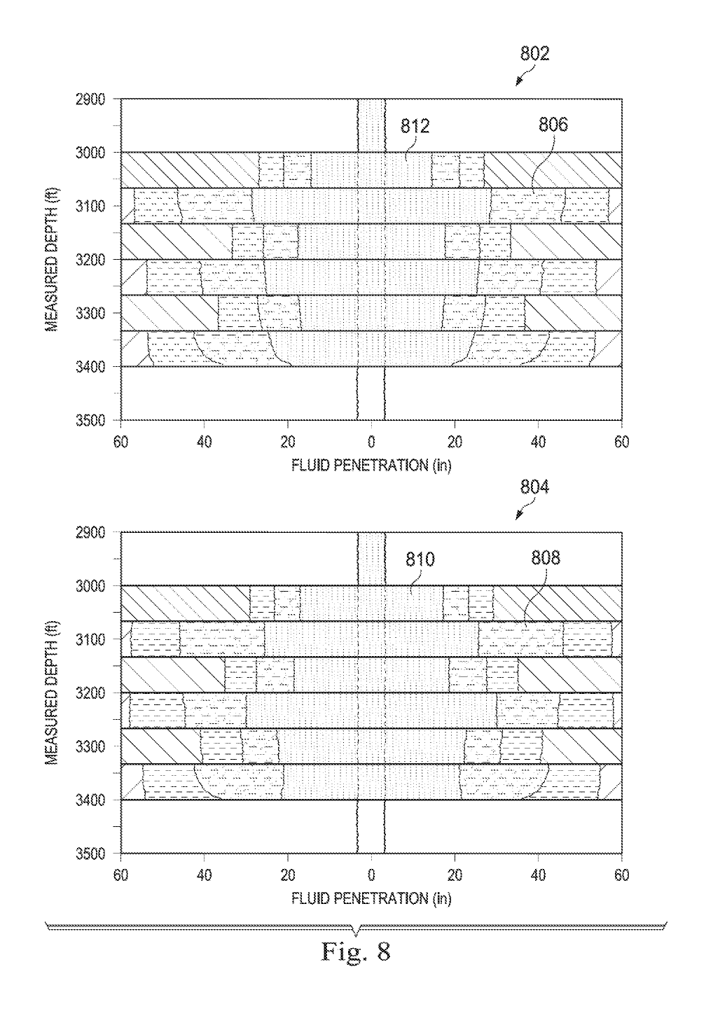

In the second illustrative simulation scenario presented in this disclosure, the treatment of a subterranean formation may comprise two operations: injection of liquid into the subterranean formation followed by injection of foam into the subterranean formation. FIG. 8 illustrates cross-sectional views 802 and 804 of an integrated wellbore-reservoir system after a simulated treatment with a liquid followed by a foam when two different simulation models are used, according to certain illustrative embodiments of the present disclosure. The simulated cross-sectional view 802 can be obtained by applying a basic foam diversion mathematical model where permeability change due to foam effect is not accounted and viscosity of foam is not based on experimental data. The simulated cross-sectional view 804 can be obtained by applying a diversion model presented in this disclosure that captures combined effect of foaming agent and resin (or some other chemical agent that provides permeability reduction and skin effect).

In this simulation scenario, the subterranean formation is treated with the liquid KCl. As illustrated by treatment fluid 806 at the simulated cross-sectional view 802 and by treatment fluid 808 at the simulated cross-sectional view 804, no diversion effect can be observed by applying either of these two diversion models as most treatment fluid enters higher permeability zones. By utilizing the combined diversion model where foam and skin models are applied at the resin-based treatment operation (second operation in this scenario), more equilibration of fluid treatment can be observed in all permeability zones, as illustrated by treatment fluid 810 at the simulated cross-sectional view 804. It can be observed that in this case lower permeability zones received more fluid. On the other hand, simulation results obtained by applying the basis foam model illustrated by treatment fluid 812 at the simulated cross-sectional view 802 do not show equilibration of fluid treatment in all formation zones.

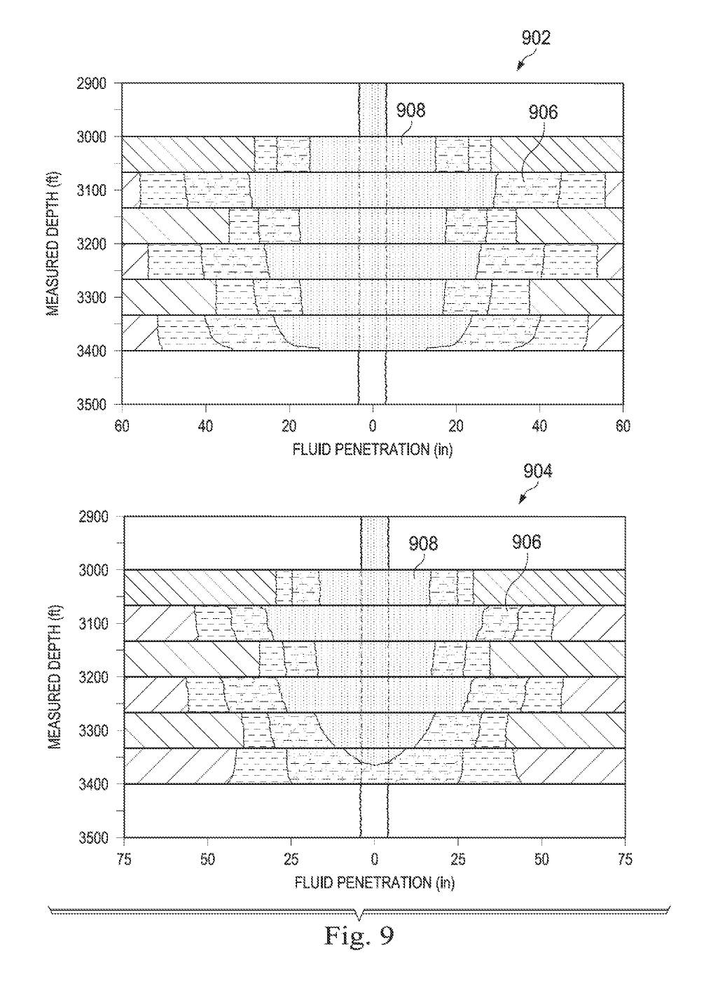

In the third illustrative simulation scenario presented herein, the treatment of a subterranean formation may comprise two operations: injection of the foamed KCl into the subterranean formation followed by injection of foam/skin resin system into the subterranean formation. FIG. 9 illustrates cross-sectional views 902 and 904 of an integrated wellbore-reservoir system after a treatment with the foamed KCl (e.g., treatment fluid 906) followed by the foam/skin resin system (e.g., treatment fluid 908) when two different simulation models are used, according to certain illustrative embodiments of the present disclosure. The simulated cross-sectional view 902 can be obtained by applying a basic foam diversion mathematical model where permeability change due to foam effect is not accounted and viscosity of foam is not based on experimental data. The simulated cross-sectional view 904 can be obtained by applying a diversion model presented in this disclosure that captures combined effect of foaming agent and resin (or some other chemical agent that provides permeability reduction and skin effect).

In this scenario, a first treatment fluid 906 (e.g., the foamed KCl provided to the subterranean formation in the first injection operation) can provide a certain level of equilibration in different permeability zones, as illustrated in the simulated cross-sectional view 904 in FIG. 9. When the injection of foamed KCl is followed by injection of foam/skin resin (treatment fluid 908), the resin system with skin effect and foam effect is not able to enter ‘foamed’ KCl formation and to be delivered to the full 400-ft formation interval, as illustrated by treatment fluid 908 in FIG. 9. The treated wellbore-reservoir system 904 experiences significant fluid diversion from high permeability formation zones to low permeability formation zones. On the other hand, the simulations results illustrated with the cross-sectional view 902 obtained by applying the basic foam diversion model fail to emulate fluid diversion that occurs in the subterranean formation after injecting foamed KCl (e.g., treatment fluid 906) followed by foam/skin resin system (e.g., treatment fluid 908).

In addition to the modeling experiments illustrated in FIGS. 7-9, the “wet” experiment is also conducted in relation to embodiments of the present disclosure. For certain embodiments, foamed KCl treatment can be applied into a subterranean formation at various permeability zones for determining the foam bubble density constant, n*, in order to validate the foam bubble density constant used in the model for fluid diversion (e.g., in equations (8) and (9)). In accordance with embodiments of the present disclosure, the skin model developed in the present disclosure can be based on an average 50% regained permeability result obtained when the resin system is treated into sand packs at various permeability and temperature values.

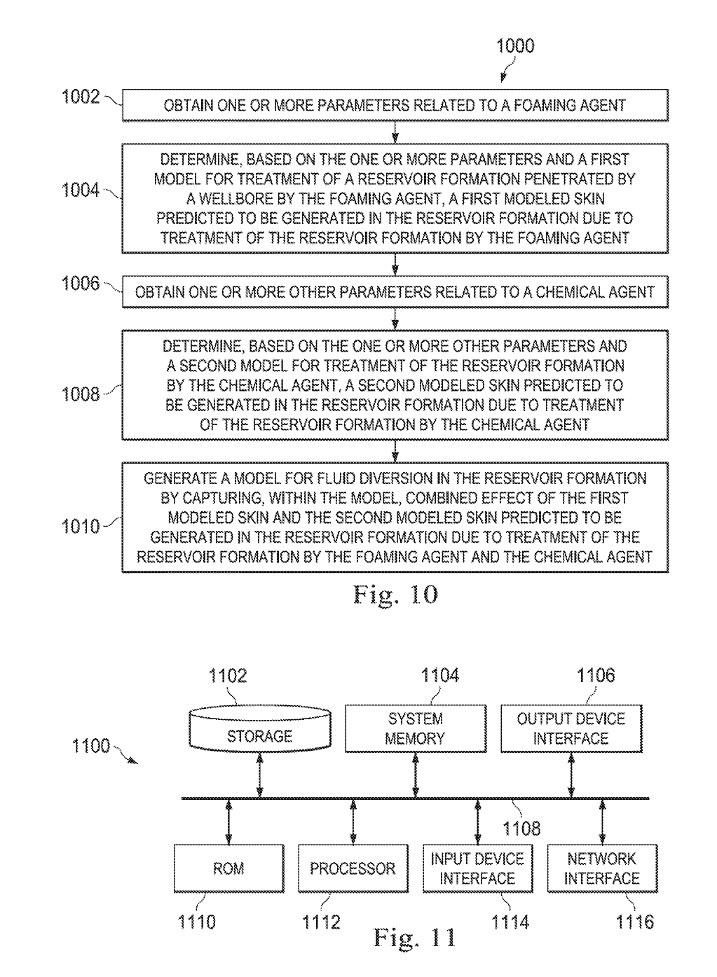

Discussion of an illustrative method of the present disclosure will now be made with reference to FIG. 10, which is a flow chart 1000 of a method for modeling fluid diversion, according to certain illustrative embodiments of the present disclosure. In one or more embodiments, the operations of method 1000 of FIG. 10 may be performed by a computing system placed on a location remotely from a well site. In one or more other embodiments, the operations of method 1000 of FIG. 10 may be performed by a computing system located on a well site (e.g., computing system 22 of system 1 for fluid treatment, illustrated in FIG. 1). The method begins at 1002 by obtaining one or more parameters (e.g., parameters 304 of the modeling method 300 illustrated in FIG. 3) related to a foaming agent (e.g., foamed KCl). At 1004, based on the one or more parameters and a first model for treatment of a reservoir formation penetrated by a wellbore by the foaming agent (e.g., foam model 306 illustrated in FIG. 3), a first modeled skin predicted to be generated in the reservoir formation due to treatment of the reservoir formation by the foaming agent (e.g., skin effect 310 due to foaming agent) may be determined. At 1006, one or more other parameters (e.g., parameters 314 of the modeling method 300 illustrated in FIG. 3) related to a chemical agent (e.g., resin based agent) may be obtained. At 1008, based on the one or more other parameters and a second model for treatment of the reservoir formation by the chemical agent (e.g., skin resin model 316 illustrated in FIG. 3), a second modeled skin predicted to be generated in the reservoir formation due to treatment of the reservoir formation by the chemical agent (e.g., skin effect 318 of FIG. 3 due to resin) may be determined. At 1010, a model (e.g., combined model 320 of FIG. 3) for fluid diversion in the reservoir formation may be generated by capturing, within the model, combined effect of the first modeled skin and the second modeled skin predicted to be generated in the reservoir formation due to treatment of the reservoir formation by the foaming agent and the chemical agent.

FIG. 11 is a block diagram of an illustrative computing system 1100 (also illustrated in FIG. 1 as computing system 22) in which embodiments of the present disclosure may be implemented adapted for modeling fluid diversion in integrated wellbore-reservoir systems. For example, some operations of the method 300 of FIG. 3, the operations of method 400 of FIG. 4, and the operations of method 1000 of FIG. 10, as described above, may be implemented using the computing system 1100. The computing system 1100 can be a computer, phone, personal digital assistant (PDA), or any other type of electronic device. Such an electronic device includes various types of computer readable media and interfaces for various other types of computer readable media. As shown in FIG. 11, the computing system 1100 includes a permanent storage device 1102, a system memory 1104, an output device interface 1106, a system communications bus 1108, a read-only memory (ROM) 1110, processing unit(s) 1112, an input device interface 1114, and a network interface 1116.

The bus 1108 collectively represents all system, peripheral, and chipset buses that communicatively connect the numerous internal devices of the computing system 1100. For instance, the bus 1108 communicatively connects the processing unit(s) 1112 with the ROM 1110, the system memory 1104, and the permanent storage device 1102.

From these various memory units, the processing unit(s) 1112 retrieves instructions to execute and data to process in order to execute the processes of the subject disclosure. The processing unit(s) can be a single processor or a multi-core processor in different implementations.

The ROM 1110 stores static data and instructions that are needed by the processing unit(s) 1112 and other modules of the computing system 1100. The permanent storage device 1102, on the other hand, is a read-and-write memory device. This device is a non-volatile memory unit that stores instructions and data even when the computing system 1100 is off. Some implementations of the subject disclosure use a mass-storage device (such as a magnetic or optical disk and its corresponding disk drive) as the permanent storage device 1102.

Other implementations use a removable storage device (such as a floppy disk, flash drive, and its corresponding disk drive) as the permanent storage device 1102. Like the permanent storage device 1102, the system memory 1104 is a read-and-write memory device. However, unlike the storage device 1102, the system memory 1104 is a volatile read-and-write memory, such a random access memory. The system memory 1104 stores some of the instructions and data that the processor needs at runtime. In some implementations, the processes of the subject disclosure are stored in the system memory 1104, the permanent storage device 1102, and/or the ROM 1110. For example, the various memory units include instructions for computer aided pipe string design based on existing string designs in accordance with some implementations. From these various memory units, the processing unit(s) 1112 retrieves instructions to execute and data to process in order to execute the processes of some implementations.

The bus 1108 also connects to the input and output device interfaces 1114 and 1106. The input device interface 1114 enables the user to communicate information and select commands to the computing system 1100. Input devices used with the input device interface 1114 include, for example, alphanumeric, QWERTY, or T9 keyboards, microphones, and pointing devices (also called “cursor control devices”). The output device interfaces 1106 enables, for example, the display of images generated by the computing system 1100. Output devices used with the output device interface 1106 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 11, the bus 1108 also couples the computing system 1100 to a public or private network (not shown) or combination of networks through a network interface 1116. Such a network may include, for example, a local area network (“LAN”), such as an Intranet, or a wide area network (“WAN”), such as the Internet. Any or all components of the computing system 1100 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, some operations of the method 300 of FIG. 3, the operations of method 400 of FIG. 4, and the operations of method 1000 of FIG. 10, as described above, may be implemented using the computing system 1100 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

A computer-implemented method for modeling fluid diversion has been described in the present disclosure and may generally include: obtaining one or more parameters related to a foaming agent; determining, based on the one or more parameters and a first model for treatment of a reservoir formation penetrated by a wellbore by the foaming agent, a first modeled skin predicted to be generated in the reservoir formation due to treatment of the reservoir formation by the foaming agent; obtaining one or more other parameters related to a chemical agent; determining, based on the one or more other parameters and a second model for treatment of the reservoir formation by the chemical agent, a second modeled skin predicted to be generated in the reservoir formation due to treatment of the reservoir formation by the chemical agent; and generating a model for fluid diversion in the reservoir formation by capturing, within the model, combined effect of the first modeled skin and the second modeled skin predicted to be generated in the reservoir formation due to treatment of the reservoir formation by the foaming agent and the chemical agent. Further, a computer-readable storage medium having instructions stored therein, which when executed by a computer cause the computer to perform a plurality of functions, including functions to: obtain one or more parameters related to a foaming agent; determine, based on the one or more parameters and a first model for treatment of a reservoir formation penetrated by a wellbore by the foaming agent, a first modeled skin predicted to be generated in the reservoir formation due to treatment of the reservoir formation by the foaming agent; obtain one or more other parameters related to a chemical agent; determine, based on the one or more other parameters and a second model for treatment of the reservoir formation by the chemical agent, a second modeled skin predicted to be generated in the reservoir formation due to treatment of the reservoir formation by the chemical agent; and generate a model for fluid diversion in the reservoir formation by capturing, within the model, combined effect of the first modeled skin and the second modeled skin predicted to be generated in the reservoir formation due to treatment of the reservoir formation by the foaming agent and the chemical agent. For the foregoing embodiments, the method or functions may include any one of the following operations, alone or in combination with each other: Creating a geometry of the wellbore; Creating a pumping schedule with a fluid system comprising the foaming agent and the chemical agent; Obtaining one or more properties of the reservoir formation; Applying, for the geometry of the wellbore and the pumping schedule using the one or more properties of the reservoir formation, the generated model for fluid diversion to simulate treatment of the reservoir formation by the foaming agent and the chemical agent; Displaying, on a display device, visual representation of the simulated treatment of the reservoir formation by the foaming agent and the chemical agent; Initiating, based on the simulated treatment of the reservoir formation, treatment of the reservoir formation by the foaming agent and the chemical agent for fluid diversion among two or more layers of the reservoir formation; Generating the model for fluid diversion further comprises: determining, based on the one or more parameters and the first model, at least one of a density of bubbles associated with treatment of the reservoir formation by the foaming agent or a viscosity of the foaming agent, and generating the model for fluid diversion based on the at least one of the density of bubbles or the viscosity of the foaming agent.

The one or more properties of the reservoir formation comprise at least one of: a permeability of the reservoir formation, a porosity of the reservoir formation, or a number of layers in the reservoir formation; The one or more parameters related to the foaming agent comprise at least one of: a foam generation constant, a foam coalescence rate, a gas trapping parameter, or a maximum gas saturation; The chemical agent comprises a resin based chemical agent; The one or more other parameters comprise at least one of: information about a flow rate in the reservoir formation due to treatment of the reservoir formation by the resin based chemical agent, a volume concentration of the resin based chemical agent in the reservoir formation, a porosity of a resin cake formed in the reservoir formation due to treatment of the reservoir formation by the resin based chemical agent, or a permeability of the resin based chemical agent in the reservoir formation; The first modeled skin is predicted to be generated in the reservoir formation due to treatment of the reservoir formation by a viscous foaming agent; The reservoir formation comprises at least one of carbonate, sandstone, or clay.

Likewise, a system for modeling fluid diversion has been described and include at least one processor and a memory coupled to the processor having instructions stored therein, which when executed by the processor, cause the processor to perform functions, including functions to: obtain one or more parameters related to a foaming agent; determine, based on the one or more parameters and a first model for treatment of a reservoir formation penetrated by a wellbore by the foaming agent, a first modeled skin predicted to be generated in the reservoir formation due to treatment of the reservoir formation by the foaming agent; obtain one or more other parameters related to a chemical agent; determine, based on the one or more other parameters and a second model for treatment of the reservoir formation by the chemical agent, a second modeled skin predicted to be generated in the reservoir formation due to treatment of the reservoir formation by the chemical agent; and generate a model for fluid diversion in the reservoir formation by capturing, within the model, combined effect of the first modeled skin and the second modeled skin predicted to be generated in the reservoir formation due to treatment of the reservoir formation by the foaming agent and the chemical agent.

For any of the foregoing embodiments, the system may include any one of the following elements, alone or in combination with each other: the functions performed by the processor include functions to create a geometry of the wellbore, create a pumping schedule with a fluid system comprising the foaming agent and the chemical agent, obtain one or more properties of the reservoir formation, and apply, for the geometry of the wellbore and the pumping schedule using the one or more properties of the reservoir formation, the generated model for fluid diversion to simulate treatment of the reservoir formation by the foaming agent and the chemical agent; the functions performed by the processor include functions to display, on a display device, visual representation of the simulated treatment of the reservoir formation by the foaming agent and the chemical agent; the functions performed by the processor include functions to initiate, based on the simulated treatment of the reservoir formation, treatment of the reservoir formation by the foaming agent and the chemical agent for fluid diversion among two or more layers of the reservoir formation; the functions for generating the model for fluid diversion performed by the processor include functions to: determine, based on the one or more parameters and the first model, at least one of a density of bubbles associated with treatment of the reservoir formation by the foaming agent or a viscosity of the foaming agent, and generate the model for fluid diversion based on the at least one of the density of bubbles or the viscosity of the foaming agent.

Embodiments of the present disclosure relate to developing and applying a novel model for fluid diversion that captures the combined effect of foam-based and resin-based diverter/sand control system. The flow diversion can be achieved with permeability reduction due to gas immobility, viscosity and skin increase inside a subterranean formation. The model for fluid diversion presented herein couples the permeability, viscosity and skin interactions with the fluid flow. The presented model for fluid diversion eliminates the need for solving the complete foam balance equations. The skin increase associated with foam and resin can be directly incorporated into the fluid flow model. The model for fluid diversion presented herein is accurate, fast and captures physical effects of both foam and resin (or, in general, some other chemical agent that imposes a formation permeability reduction and provides skin effect).

The presented model for fluid diversion can predict the effect of diverters on flow distribution inside the reservoir and, hence, in the entire integrated wellbore-reservoir system accurately and quickly. The model for fluid diversion presented herein efficiently predicts the permeability of the reservoir, viscosity of the foam, and skin due to resin. Modeling foam and resin effects inside the reservoir in the simulator for simulating flow distribution both in real time and design modes provides engineers an accurate representation of conditions in the reservoir. Flow computations are more accurate comparing to the prior art models taking into account accurate predictions of permeability and viscosity of the foam. The method for modeling fluid diversion presented in this disclosure can handle the foam flow with resin for open-hole wells obtaining a robust, stable and accurate numerical solution throughout the pumping schedule.

The novel one-dimensional flow model incorporating various diverters represents a very rigorous approach accurately and efficiently incorporating foam and resin effects, the flow computations, permeability of the formation and viscosity of the foam for arbitrarily drilled wells. The model for flow diversion developed herein can be applied for various treatment processes, such as: hydraulic fracturing, treatments with advanced acids, digital temperature sensing, and the like. The flow model presented in this disclosure is fast since it eliminates the need to solve for foam population balance. The presented model for flow diversion includes skin effect due to resin in the one-dimensional model solving for flow, which eliminates the need to solve for multi-dimensional models. The model presented herein can accurately predict the flow distribution in the reservoir formation.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 1100 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the Figures illustrate the architecture, functionality, and operation of possible implementations of systems, methods and computer program products according to various embodiments of the present disclosure. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

1. A computer-implemented method for modeling fluid diversion, the method comprising:
obtaining one or more parameters related to a foaming agent;
determining, based on the one or more parameters and a first model for treatment of a reservoir formation penetrated by a wellbore by the foaming agent, a first modeled skin predicted to be generated in the reservoir formation due to treatment of the reservoir formation by the foaming agent;
obtaining one or more other parameters related to a chemical agent;
determining, based on the one or more other parameters and a second model for treatment of the reservoir formation by the chemical agent, a second modeled skin predicted to be generated in the reservoir formation due to treatment of the reservoir formation by the chemical agent; and
generating a model for fluid diversion in the reservoir formation by capturing, within the model, combined effect of the first modeled skin and the second modeled skin predicted to be generated in the reservoir formation due to treatment of the reservoir formation by the foaming agent and the chemical agent.

2. The method of claim 1, further comprising:
creating a geometry of the wellbore;
creating a pumping schedule with a fluid system comprising the foaming agent and the chemical agent;
obtaining one or more properties of the reservoir formation; and
applying, for the geometry of the wellbore and the pumping schedule using the one or more properties of the reservoir formation, the generated model for fluid diversion to simulate treatment of the reservoir formation by the foaming agent and the chemical agent.

3. The method of claim 2, further comprising:
displaying, on a display device, visual representation of the simulated treatment of the reservoir formation by the foaming agent and the chemical agent; or
initiating, based on the simulated treatment of the reservoir formation, treatment of the reservoir formation by the foaming agent and the chemical agent for fluid diversion among two or more layers of the reservoir formation.

4. (canceled)

5. The method of claim 2, wherein the one or more properties of the reservoir formation comprise at least one of: a permeability of the reservoir formation, a porosity of the reservoir formation, or a number of layers in the reservoir formation.

6. The method of claim 1, wherein:
the one or more parameters related to the foaming agent comprise at least one of: a foam generation constant, a foam coalescence rate, a gas trapping parameter, or a maximum gas saturation; or
the chemical agent comprises a resin based chemical agent.

7. The method of claim 1, wherein generating the model for fluid diversion further comprises:
determining, based on the one or more parameters and the first model, at least one of a density of bubbles associated with treatment of the reservoir formation by the foaming agent or a viscosity of the foaming agent; and
generating the model for fluid diversion based on the at least one of the density of bubbles or the viscosity of the foaming agent.

8. (canceled)

9. The method of claim 6, wherein the one or more other parameters comprise at least one of: information about a flow rate in the reservoir formation due to treatment of the reservoir formation by the resin based chemical agent, a volume concentration of the resin based chemical agent in the reservoir formation, a porosity of a resin cake formed in the reservoir formation due to treatment of the reservoir formation by the resin based chemical agent, or a permeability of the resin based chemical agent in the reservoir formation.

10. The method of claim 1, wherein the first modeled skin is predicted to be generated in the reservoir formation due to treatment of the reservoir formation by a viscous foaming agent.

11. The method of claim 1, wherein the reservoir formation comprises at least one of carbonate, sandstone, or clay.

12. A system for modeling fluid diversion, the system comprising:
at least one processor; and
a memory coupled to the processor having instructions stored therein, which when executed by the processor, cause the processor to perform functions, including functions to:
obtain one or more parameters related to a foaming agent;
determine, based on the one or more parameters and a first model for treatment of a reservoir formation penetrated by a wellbore by the foaming agent, a first modeled skin predicted to be generated in the reservoir formation due to treatment of the reservoir formation by the foaming agent;
obtain one or more other parameters related to a chemical agent;
determine, based on the one or more other parameters and a second model for treatment of the reservoir formation by the chemical agent, a second modeled skin predicted to be generated in the reservoir formation due to treatment of the reservoir formation by the chemical agent; and
generate a model for fluid diversion in the reservoir formation by capturing, within the model, combined effect of the first modeled skin and the second modeled skin predicted to be generated in the reservoir formation due to treatment of the reservoir formation by the foaming agent and the chemical agent.

13. The system of claim 12, wherein the functions performed by the processor include functions to:
create a geometry of the wellbore;
create a pumping schedule with a fluid system comprising the foaming agent and the chemical agent;
obtain one or more properties of the reservoir formation; and
apply, for the geometry of the wellbore and the pumping schedule using the one or more properties of the reservoir formation, the generated model for fluid diversion to simulate treatment of the reservoir formation by the foaming agent and the chemical agent.

14. The system of claim 13, wherein the functions performed by the processor include:
functions to display, on a display device, visual representation of the simulated treatment of the reservoir formation by the foaming agent and the chemical agent; or
functions to initiate, based on the simulated treatment of the reservoir formation, treatment of the reservoir formation by the foaming agent and the chemical agent for fluid diversion among two or more layers of the reservoir formation.

15. (canceled)

16. The system of claim 13, wherein the one or more properties of the reservoir formation comprise at least one of: a permeability of the reservoir formation, a porosity of the reservoir formation, or a number of layers in the reservoir formation.

17. The system of claim 12, wherein:
the one or more parameters related to the foaming agent comprise at least one of: a foam generation constant, a foam coalescence rate, a gas trapping parameter, or a maximum gas saturation; or
the chemical agent comprises a resin based chemical agent.

18. The system of claim 12, wherein the functions for generating the model for fluid diversion performed by the processor include functions to:
determine, based on the one or more parameters and the first model, at least one of a density of bubbles associated with treatment of the reservoir formation by the foaming agent or a viscosity of the foaming agent; and
generate the model for fluid diversion based on the at least one of the density of bubbles or the viscosity of the foaming agent.

19. (canceled)

20. The system of claim 17, wherein the one or more other parameters comprise at least one of: information about a flow rate in the reservoir formation due to treatment of the reservoir formation by the resin based chemical agent, a volume concentration of the resin based chemical agent in the reservoir formation, a porosity of a resin cake formed in the reservoir formation due to treatment of the reservoir formation by the resin based chemical agent, or a permeability of the resin based chemical agent in the reservoir formation.

21. The system of claim 12, wherein the first modeled skin is predicted to be generated in the reservoir formation due to treatment of the reservoir formation by a viscous foaming agent.

22. The system of claim 12, wherein the reservoir formation comprises at least one of carbonate, sandstone, or clay.

23. A computer-readable storage medium having instructions stored therein, which when executed by a computer cause the computer to perform a plurality of functions, including functions to:
obtain one or more parameters related to a foaming agent;
determine, based on the one or more parameters and a first model for treatment of a reservoir formation penetrated by a wellbore by the foaming agent, a first modeled skin predicted to be generated in the reservoir formation due to treatment of the reservoir formation by the foaming agent;
obtain one or more other parameters related to a chemical agent;
determine, based on the one or more other parameters and a second model for treatment of the reservoir formation by the chemical agent, a second modeled skin predicted to be generated in the reservoir formation due to treatment of the reservoir formation by the chemical agent; and
generate a model for fluid diversion in the reservoir formation by capturing, within the model, combined effect of the first modeled skin and the second modeled skin predicted to be generated in the reservoir formation due to treatment of the reservoir formation by the foaming agent and the chemical agent.

24. The computer-readable storage medium of claim 23, wherein the instructions further perform functions to:
create a geometry of the wellbore;
create a pumping schedule with a fluid system comprising the foaming agent and the chemical agent;
obtain one or more properties of the reservoir formation; and
apply, for the geometry of the wellbore and the pumping schedule using the one or more properties of the reservoir formation, the generated model for fluid diversion to simulate treatment of the reservoir formation by the foaming agent and the chemical agent.
